(19) United States
(12) Patent Application Publication
(10) Pub. No.: US 2021/0003004 A1
(43) Pub. Date: Jan. 7, 2021

(54) Method and device for identifying structure of flow field in unconventional gas reservoir

(71) Applicant: UNIVERSITY OF SCIENCE AND TECHNOLOGY BEIJING, Beijing (CN)

(72) Inventors: WEIYAO ZHU, Beijing (CN); MING YUE, Beijing (CN); JIANFA WU, Chengdu (CN); KAI LIU, Beijing (CN); ZHEN CHEN, Beijing (CN); ZHIYONG SONG, Beijing (CN); DEBIN KONG, Beijing (CN)

(21) Appl. No.: 17/027,951

(22) Filed: Sep. 22, 2020

(30) Foreign Application Priority Data
Sep. 4, 2020 (CN) 2020109202076

(51) Int. Cl. E21B 49/00; E21B 47/10

(52) U.S. Cl. CPC E21B 49/008; E21B 43/2605; E21B 47/10

(57) ABSTRACT

A method for identifying structure of flow field in unconventional gas reservoir is provided. The unconventional gas reservoir comprises at least one horizontal well, for any horizontal well in the at least one horizontal well, the method comprises: during fracturing fluid flowback stage, obtaining first production data, and drawing an actual production curve diagram of the fracturing fluid flowback stage; obtaining reservoir physical parameters corresponding to different fracture network forms and second production data, and performing numerical simulations on water production rate, gas production rate and casing pressure of the fracturing fluid flowback stage, and drawing layouts of structure of flow field corresponding to different fracture network forms of the fracturing fluid flowback stage; and comparing the actual production curve diagram with the layouts of structure of flow field corresponding to different fracture network forms to identify structure of flow field of the reservoir after fracturing.

### TECHNICAL FIELD

The present disclosure relates to the technical field of unconventional gas development, and in particular to a method and device for identifying structure of flow field in unconventional gas reservoir.

### BACKGROUND

Unconventional oil and gas reservoirs refer to oil and gas reservoirs that are different from conventional oil and gas reservoirs in their characteristics, accumulation mechanism and exploitation technology. Among them, unconventional gas mainly comprises tight gas, shale gas, and coalbed methane, etc. In the process of unconventional gas development, large-scale volume fracturing of the reservoir is usually used to form a fracture network to obtain better oil and gas flow channels, thereby obtaining greater oil and gas production. After fracturing, the geometry form of the fracture network formed around each horizontal well and the corresponding structure of flow field are related to the evaluation of later production capacity and the design and adjustment of the development plan. Therefore, it is necessary to make a clear description of the structure of flow field of the reservoir corresponding to the production well.

### SUMMARY

Some embodiments of the present disclosure provide a method and device for identifying the structure of flow field in unconventional gas reservoir to realize the identification of the structure of flow field in the reservoir after fracturing.

A method for identifying structure of flow field in unconventional gas reservoir is provided. The unconventional gas reservoir comprises at least one horizontal well, and in the case of ignoring inter-well interference, for any horizontal well in the at least one horizontal well, the method for identifying structure of flow field in unconventional gas reservoir comprises: during fracturing fluid flowback stage, obtaining first production data, and drawing an actual production curve diagram of the fracturing fluid flowback stage according to the first production data; obtaining reservoir physical parameters corresponding to different fracture network forms and second production data, and performing numerical simulations on water production rate, gas production rate and casing pressure of the fracturing fluid flowback stage, and according to the results of numerical simulations, drawing layouts of structure of flow field corresponding to different fracture network forms of the fracturing fluid flowback stage; and comparing the actual production curve diagram with the layouts of structure of flow field corresponding to different fracture network forms to identify structure of flow field of the reservoir after fracturing.

According to at least one embodiment of the present disclosure, that obtaining second production data and reservoir physical parameters corresponding to different fracture network forms, and performing numerical simulations on water production rate, gas production rate and casing pressure in the fracturing fluid flowback stage, and according to the results of numerical simulation, drawing layouts of structure of flow field corresponding to different fracture network forms in the fracturing fluid flowback stage, comprises: presetting fracture network form of the reservoir after fracturing to be a feather-like fracture network, a meshed fracture network, a tufted fracture network, or a tree-like fracture network, obtaining the second production data, and obtaining reservoir physical parameters corresponding to the four fracture network forms of feather-like fracture network, meshed fracture network, tufted fracture network, and tree-like fracture network respectively; performing numerical simulations on the water production rate, the gas production rate and the casing pressure of the horizontal well according to the reservoir physical parameters corresponding to the tufted fracture network and the second production data, and according to the result of numerical simulation, drawing a layout of structure of flow field corresponding to the tufted fracture network in the fracturing fluid flowback stage; performing numerical simulations on the water production rate, the gas production rate and the casing pressure of the horizontal well according to the reservoir physical parameters corresponding to the meshed fracture network and the second production data, and according to the result of numerical simulation, drawing a layout of structure of flow field corresponding to the meshed fracture network in the fracturing fluid flowback stage; performing numerical simulations on the water production rate, the gas production rate and the casing pressure of the horizontal well according to the reservoir physical parameters corresponding to the tree-like fracture network and the second production data, and according to the result of numerical simulation, drawing a layout of structure of flow field corresponding to the tree-like fracture network in the fracturing fluid flowback stage; and performing numerical simulations on the water production rate, the gas production rate and the casing pressure of the horizontal well according to the reservoir physical parameters corresponding to the feather-like fracture network and the second production data, and according to the result of numerical simulation, drawing a layout of structure of flow field corresponding to the feather-like fracture network in the fracturing fluid flowback stage.

According to at least one embodiment of the present disclosure, the reservoir physical parameters corresponding to the meshed fracture network comprise equivalent permeability corresponding to the meshed fracture network, wherein formula of the equivalent permeability corresponding to the meshed fracture network is:

$${K}_{e 1} = {\sum }_{i = 1}^{n} \frac{{W}_{i}^{4}}{{12 }_{i} ( {W}_{i} + {X}_{i} )} + {\sum }_{i = 1}^{n} \frac{{X}_{i}}{{W}_{i} + {X}_{i}} {K}_{m}$$

wherein, Kₑ₁ is overall permeability of fracture-matrix system of the meshed fracture network;

Kₘ is permeability of matrix system;

W is fracture aperture;

X is fracture spacing; and

n is number of fracture stage.

According to at least one embodiment of the present disclosure, the reservoir physical parameters corresponding to the tufted fracture network comprise equivalent permeability corresponding to the tufted fracture network, wherein formula of the equivalent permeability corresponding to the tufted fracture network is:

$${K}_{e 2} = {\sum }_{i = 1}^{n} \frac{{W}_{i}^{3} {cos}^{2} γ}{12 ( {W}_{i} + {X}_{i} )} + {\sum }_{i = 1}^{n} \frac{{X}_{i}}{{W}_{i} + {X}_{i}} {K}_{m}$$

wherein, Kₑ₂ is overall permeability of fracture-matrix system of the tufted fracture network;

Kₘ is permeability of matrix system;

W is fracture aperture;

X is fracture spacing;

n is number of fracture stage; and

γ is angle between fractures.

According to at least one embodiment of the present disclosure, the reservoir physical parameters corresponding to the tufted fracture network comprise equivalent permeability corresponding to the feather-like fracture network, wherein formula of the equivalent permeability corresponding to the feather-like fracture network is:

$${K}_{e 3} = {\sum }_{i = 1}^{n} \frac{{W}_{i} {cos}^{2} γ}{{W}_{i} + {X}_{i}} {K}_{m} + {\sum }_{i = 1}^{n} \frac{{X}_{i}}{{W}_{i} + {X}_{i}} {K}_{m}$$

wherein, Kₑ₃ is overall permeability of fracture-matrix system of the feather-like fracture network;

Kₘ is permeability of matrix system;

W is fracture aperture;

X is fracture spacing;

n is number of fracture stage; and

γ is angle between fractures.

According to at least one embodiment of the present disclosure, the reservoir physical parameters corresponding to the tufted fracture network comprise equivalent permeability corresponding to the tree-like fracture network, wherein formula of the equivalent permeability corresponding to the tree-like fracture network is:

$${K}_{e 4} = {\sum }_{i = 1}^{n} \frac{{W}_{i}}{{X}_{i} + {W}_{i}} \frac{{Dd}_{max}^{3 + {D}_{τ}} ln ( {r}_{c} \text{/} {r}_{w} )}{256 ( 3 + {D}_{τ} - D ) {l}_{0}^{{D}_{τ}}} \frac{1 - γ}{1 - {γ}^{m + 1}}$$

wherein, Kₑ₄ is overall permeability of fracture-matrix system of the tree-like fracture network;

Kₘ is permeability of matrix system;

W is fracture aperture;

X is fracture spacing;

n is number of fracture stage;

γ is angle between fractures;

l₀ is length of level 0 bifurcation;

D is fractal dimension of fracture;

D_{τ} is tortuosity dimension;

dₘₐₓ is maximum opening of primary fracture;

m is maximum bifurcation levels of fracture;

r_{c} is maximum extension length of fracture; and

r_{w} is radius of wellbore.

According to at least one embodiment of the present disclosure, that comparing the actual production curve diagram with the layouts of structure of flow field corresponding to different fracture network forms to identify structure of flow field of the reservoir after fracturing, comprises: comparing the actual production curve diagram with the layout of structure of flow field corresponding to the feather-like fracture network, the layout of structure of flow field corresponding to the meshed fracture network, the layout of structure of flow field corresponding to the tufted fracture network, and the layout of structure of flow field corresponding to the tree-like fracture network respectively, and identifying structure of flow field of the reservoir after fracturing according to the changing trend of production curves presented by the four layouts of structure of flow field.

According to at least one embodiment of the present disclosure, classification basis for identifying structure of flow field of the reservoir after fracturing comprises: when the actual production curve diagram does not include pure water production stage and water production rate rising stage, and the casing pressure decreases continuously, the structure of flow field of the reservoir after fracturing is structure of flow field formed by meshed fracture network; when the actual production curve diagram comprises a pure water production stage, and a water production rate rising and casing pressure rising stage, the structure of flow field of the reservoir after fracturing is structure of flow field formed by tufted fracture network; when the actual production curve diagram comprises a pure water production stage, and does not include water production rate rising stage, and gas production rate is maintained for at least 240 hours without decreasing, the structure of flow field of the reservoir after fracturing is structure of flow field formed by tree-like fracture network; and when the actual production curve diagram comprises a pure water production stage, and does not include water production rate rising stage, and gas production rate rapidly drops after rising, the structure of flow field of the reservoir after fracturing is structure of flow field formed by feather-like fracture network.

According to at least one embodiment of the present disclosure, the first production data comprises water production rate, water production, gas production rate, gas production and casing pressure.

A device for identifying structure of flow field in unconventional gas reservoir is provided. The device comprises a processor and a memory. The memory stores computer program instructions suitable for execution by the processor, and when the computer program instructions are executed by the processor, one or more steps of the method for identifying structure of flow field in unconventional gas reservoir according to claim 1 are executed.

### BRIEF DESCRIPTION OF FIGURES

The drawings illustrate exemplary embodiments of the present disclosure and are used to explain the principles of the present disclosure together with their descriptions. These drawings are included to provide a further understanding of the present disclosure, and the drawings are included in this specification and constitute a part of this specification.

FIG. 1 is a schematic diagram of a meshed fracture network according to some embodiments of the present disclosure;

FIG. 2 is a schematic diagram of a tufted fracture network according to some embodiments of the present disclosure;

FIG. 3 is a schematic diagram of a feather-like fracture network according to some embodiments of the present disclosure;

FIG. 4 is a schematic diagram of a tree-like fracture network according to some embodiments of the present disclosure;

FIG. 5 is an actual production curve diagram of a method for identifying structure of flow field in unconventional gas reservoir according to some embodiments of the present disclosure;

FIG. 6 is a layout of structure of flow field corresponding to meshed fracture network of a method for identifying structure of flow field in unconventional gas reservoir according to some embodiments of the present disclosure;

FIG. 7 is a layout of structure of flow field corresponding to tufted fracture network of a method for identifying structure of flow field in unconventional gas reservoir according to some embodiments of the present disclosure;

FIG. 8 is a layout of structure of flow field corresponding to tree-like fracture network of a method for identifying structure of flow field in unconventional gas reservoir according to some embodiments of the present disclosure;

FIG. 9 is a layout of structure of flow field corresponding to feather-like fracture network of a method for identifying structure of flow field in unconventional gas reservoir according to some embodiments of the present disclosure;

FIG. 10 is a comparison diagram of a simulated gas production curve and an actual gas production curve of a structure of flow field with tufted fracture network according to some embodiments of the present disclosure.

### DETAILED DESCRIPTION

The disclosure will be further described in detail below with reference to the drawings and embodiments. It can be understood that the specific embodiments described herein are only used for explaining related content, rather than limiting the present disclosure. It should also be noted that, for ease of description, only parts related to the present disclosure are shown in the drawings.

It should be noted that the embodiments in the present disclosure and the features in the embodiments can be combined with each other without conflict. The disclosure will be described in detail below with reference to the drawings and in conjunction with the embodiments.

It should be noted that the step numbers in the text are only used to facilitate the explanation of the specific embodiments, and are not used to limit the order of execution of the steps.

The method provided by some embodiments of the present disclosure can be executed by a related processor, and the following descriptions are made by taking the processor as the execution body as an example. The executive body can be adjusted according to specific cases, such as servers, electronic devices, computers, etc.

In related technologies, the micro-seismic monitoring technology is mostly used to describe the fracturing fracture network. In the micro-seismic monitoring technology usually uses the micro-seismic induced by the rise of formation pressure during the fracturing process is generally used, seismic wave data is collected by the ground monitoring system, and signal identification and process of the data is performed to record and locate each micro-seismic source. The distribution of each micro-seismic source can reflect the fracture profile in the formation.

There are some shortcomings in the way of obtaining fracture morphology data through micro-seismic monitoring technology. Firstly, due to the limitation of the current level of monitoring and data interpretation technology, the precision of micro-seismic monitoring technology is limited, and it is often difficult to reflect the true fracture conditions in the formation. Secondly, the implementation of micro-seismic projects requires higher economic costs. Finally, the fracture data obtained by micro-seismic monitoring technology is difficult to apply to the numerical simulation calculation process of oil and gas reservoirs, so it is impossible to use the fracture data obtained by micro-seismic monitoring technology to clearly identify the structure of flow field.

In view of the shortcomings of the current method of using micro-seismic monitoring technology to describe fracture network, some embodiments of the present disclosure provide a method for identifying structure of flow field in unconventional gas reservoir, so as to identify the structure of flow field in unconventional gas reservoir more accurately and reasonably. The unconventional gas reservoir comprises at least one horizontal well, and in the case of ignoring inter-well interference, for any horizontal well in the at least one horizontal well, the method for identifying structure of flow field in unconventional gas reservoir comprises S1˜S3.

S1, During fracturing fluid flowback stage, obtaining first production data, and drawing an actual production curve diagram of the fracturing fluid flowback stage according to the first production data.

In the production process of unconventional gas reservoir, after fracturing the reservoir, the fracturing fluid in the reservoir can be flowed back to prevent the injected fracturing fluid from blocking the reservoir and provide an outflow channel for oil and gas. The fracturing fluid flowback stage lasts for a short time, and the fracturing effect of the reservoir can be judged early by analyzing the production parameters of this stage. After the fracturing fluid is flowed back, the later production can be carried out as required.

In some embodiments, the first production data comprises water production rate, water production, gas production rate, gas production and casing pressure.

Optionally, the wellhead of the horizontal well is provided with at least one pressure gauge connected to the processor, and the fluid pressure in the casing (ie, casing pressure) can be measured by the at least one pressure gauge. The processor is also connected to a multiphase separation device. After the fluid flows out of the wellhead, it enters the multiphase separation device through the pipeline. By measuring time and fluid volume, the cumulative production and rate of different fluid phases (such as gas and liquid) can be obtained. After the processor collects the data signals from the pressure gauge and the multiphase separation device, it processes the data signals including water production rate, water production, gas production rate, gas production and casing pressure, thereby forming an actual production curve diagram of fracturing fluid flowback stage. The processor is also connected to a display, and the display is configured to display the actual production curve diagram generated by the processor.

S2, Obtaining reservoir physical parameters corresponding to different fracture network forms and second production data, and performing numerical simulations on water production rate, gas production rate and casing pressure of the fracturing fluid flowback stage, and according to the results of numerical simulations, drawing layouts of structure of flow field corresponding to different fracture network forms of the fracturing fluid flowback stage.

Optionally, the second production data comprises parameters such as soak time, nozzle diameter, flowback speed, and flowback time. Reservoir physical parameters comprise permeability, porosity, reservoir thickness, reservoir Young's modulus, Poisson's ratio, reservoir density and other reservoir parameters, as well as fracture aperture, number of fracture stages, fracture spacing and other fracturing related parameters. The fracturing related parameters can be obtained according to the actual fracturing construction parameters.

Optionally, the numerical simulation software is, for example, Eclipse, CMG and other oil and gas reservoir numerical simulation software.

It is understandable that the production mode selected during the numerical simulation corresponds to the actual production mode in the fracturing fluid flowback stage. For example, in the actual fracturing fluid flowback stage, the flowback is directly performed without soaking the well, and the numerical simulation process corresponds to the situation where the flowback is directly performed without soaking the well. For another example, if the flowback speed is controlled during the actual fracturing fluid flowback stage, the flowback speed is controlled during the numerical simulation process. Different production modes such as soaking, soak time, and controlling different flowback speeds will all have an impact on the change trend of the formed layouts of structure of flow field.

S3, Comparing the actual production curve diagram with the layouts of structure of flow field corresponding to different fracture network forms to identify structure of flow field of the reservoir after fracturing.

The method for identifying structure of flow field in unconventional gas reservoir provided by some embodiments of the present disclosure can more accurately identify the structure of flow field in the fractured reservoir by drawing the layouts of structure of flow field corresponding to different fracture network forms in the fracturing fluid flowback stage, and comprehensively comparing the actual production curve diagram of the fracturing fluid flowback stage with layouts of structure of flow field corresponding to different fracture network forms. It can accurately predict and calculate the later production, and provide a basis for the design and adjustment of the later production plan, so as to achieve the purpose of improving gas recovery.

In some embodiments, S2 comprises S21˜S25.

S21, Presetting fracture network form of the reservoir after fracturing to be a feather-like fracture network, a meshed fracture network, a tufted fracture network, or a tree-like fracture network, obtaining the second production data, and obtaining reservoir physical parameters corresponding to the four fracture network forms of feather-like fracture network, meshed fracture network, tufted fracture network, and tree-like fracture network respectively.

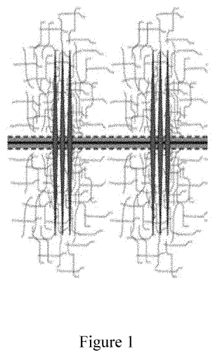

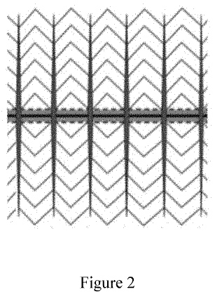

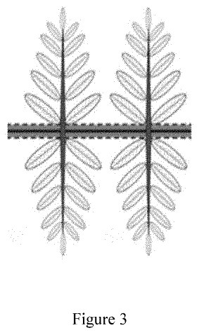

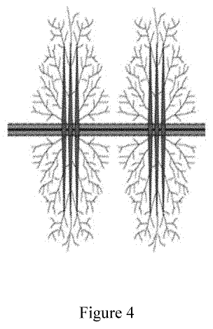

In their research, the inventors found that after the fracturing of the unconventional gas reservoir, the fracture network in the formation mainly comprises meshed fracture network (as shown in FIG. 1), tufted fracture network (as shown in FIG. 2), feather-like fracture network (as shown in FIG. 3) and tree-like fracture network (as shown in FIG. 4). By presetting the fracture network form of the reservoir after fracturing to the above four types, it is possible to simplify the simulation process and improve the simulation efficiency while ensuring the accuracy of the numerical simulation.

S22, Performing numerical simulations on the water production rate, the gas production rate and the casing pressure of the horizontal well according to the reservoir physical parameters corresponding to the tufted fracture network and the second production data, and according to the result of numerical simulation, drawing a layout of structure of flow field corresponding to the tufted fracture network in the fracturing fluid flowback stage.

In some embodiments, the reservoir physical parameters corresponding to the meshed fracture network comprise equivalent permeability corresponding to the meshed fracture network, wherein formula of the equivalent permeability corresponding to the meshed fracture network is:

$${K}_{e 1} = {\sum }_{i = 1}^{n} \frac{{W}_{i}^{4}}{12 {X}_{i} ( {W}_{i} + {X}_{i} )} + {\sum }_{i = 1}^{n} \frac{{X}_{i}}{{W}_{i} + {X}_{i}} {K}_{m} \qquad ( 1 )$$

wherein, Kₑ₁ is overall permeability of fracture-matrix system of the meshed fracture network, m²;

Kₘ is permeability of matrix system, m²;

W is fracture aperture, m;

X is fracture spacing, m; and

n is number of fracture stage.

S23, Performing numerical simulations on the water production rate, the gas production rate and the casing pressure of the horizontal well according to the reservoir physical parameters corresponding to the meshed fracture network and the second production data, and according to the result of numerical simulation, drawing a layout of structure of flow field corresponding to the meshed fracture network in the fracturing fluid flowback stage.

In some embodiments, the reservoir physical parameters corresponding to the tufted fracture network comprise equivalent permeability corresponding to the tufted fracture network, wherein formula of the equivalent permeability corresponding to the tufted fracture network is:

$${K}_{e 2} = {\sum }_{i = 1}^{n} \frac{{W}_{i}^{3} {cos}^{2} γ}{12 ( {W}_{i} + {X}_{i} )} + {\sum }_{i = 1}^{n} \frac{{X}_{i}}{{W}_{i} + {X}_{i}} {K}_{m} \qquad ( 2 )$$

wherein, Kₑ₂ is overall permeability of fracture-matrix system of the tufted fracture network, m²;

Kₘ is permeability of matrix system, m²;

W is fracture aperture, m;

X is fracture spacing, m;

n is number of fracture stage; and

γ is angle between fractures, rad.

S24, Performing numerical simulations on the water production rate, the gas production rate and the casing pressure of the horizontal well according to the reservoir physical parameters corresponding to the tree-like fracture network and the second production data, and according to the result of numerical simulation, drawing a layout of structure of flow field corresponding to the tree-like fracture network in the fracturing fluid flowback stage.

In some embodiments, the reservoir physical parameters corresponding to the tufted fracture network comprise equivalent permeability corresponding to the tree-like fracture network, wherein formula of the equivalent permeability corresponding to the tree-like fracture network is:

$${K}_{e 4} = {\sum }_{i = 1}^{n} \frac{{W}_{i}}{{X}_{i} + {W}_{i}} \frac{{Dd}_{max}^{3 + {D}_{τ}} ln ( {r}_{c} \text{/} {r}_{w} )}{256 ( 3 + {D}_{τ} - D ) {l}_{0}^{{D}_{τ}}} \frac{1 - γ}{1 - {γ}^{m + 1}} \qquad ( 3 )$$

wherein, Kₑ₄ is overall permeability of fracture-matrix system of the tree-like fracture network, m²;

Kₘ is permeability of matrix system, m²;

W is fracture aperture, m;

X is fracture spacing, m;

n is number of fracture stage;

γ is angle between fractures, rad;

l₀ is length of level 0 bifurcation, m;

D is fractal dimension of fracture;

D_{τ} is tortuosity dimension;

dₘₐₓ is maximum opening of primary fracture, m;

m is maximum bifurcation levels of fracture;

r_{c} is maximum extension length of fracture, m; and

r_{w} is radius of wellbore, m.

S25, Performing numerical simulations on the water production rate, the gas production rate and the casing pressure of the horizontal well according to the reservoir physical parameters corresponding to the feather-like fracture network and the second production data, and according to the result of numerical simulation, drawing a layout of structure of flow field corresponding to the feather-like fracture network in the fracturing fluid flowback stage.

In some embodiments, the reservoir physical parameters corresponding to the tufted fracture network comprise equivalent permeability corresponding to the feather-like fracture network, wherein formula of the equivalent permeability corresponding to the feather-like fracture network is:

$${K}_{e 3} = {\sum }_{i = 1}^{n} \frac{{W}_{i} {cos}^{2} γ}{{W}_{i} + {X}_{i}} {K}_{m} + {\sum }_{i = 1}^{n} \frac{{X}_{i}}{{W}_{i} + {X}_{i}} {K}_{m} \qquad ( 4 )$$

wherein, Kₑ₃ is overall permeability of fracture-matrix system of the feather-like fracture network, m²;

Kₘ is permeability of matrix system, m²;

W is fracture aperture, m;

X is fracture spacing, m;

n is number of fracture stage; and

γ is angle between fractures, rad.

The equivalent permeability calculated by formulas (1)˜(4) corresponding to the four fracture network forms can more accurately reflect the corresponding permeability characteristics of the four different fracture network forms. Applying the calculated equivalent permeability corresponding to the four fracture network forms in the numerical simulation process, the change trend of the simulated production curves are more in line with the actual production law, so that the obtained layouts of structure of flow field corresponding to different fracture network forms in the fracturing fluid flowback stage are more accurate.

In some embodiments, S3 comprises: comparing the actual production curve diagram with the layout of structure of flow field corresponding to the feather-like fracture network, the layout of structure of flow field corresponding to the meshed fracture network, the layout of structure of flow field corresponding to the tufted fracture network, and the layout of structure of flow field corresponding to the tree-like fracture network respectively, and identifying structure of flow field of the reservoir after fracturing according to the changing trend of production curves presented by the four layouts of structure of flow field.

Taking a fractured horizontal well A in a certain gas field as an example, the method for identifying structure of flow field in unconventional gas reservoir in some embodiments of the present disclosure will be introduced in detail.

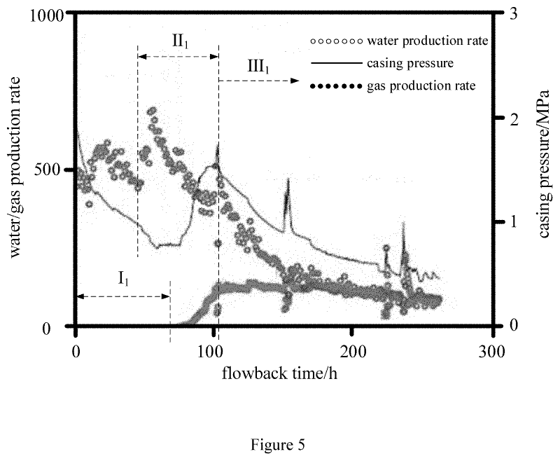

After fracturing the reservoir where the horizontal well A is located, the fracturing fluid in the reservoir is flowed back immediately, that is, directly entering the fracturing fluid flowback stage. In the fracturing fluid flowback stage, obtaining the data of water production rate, water production, gas production rate, gas production and casing pressure of horizontal well A, and drawing an actual production curve diagram (as shown in FIG. 5) of the horizontal well A of the fracturing fluid flowback stage according to these data.

Obtaining second production data and reservoir physical parameters. Soaking time is 0 h (i.e. direct flowback and without soaking). The flowback speed is controlled by the nozzle diameter. The nozzle diameter is 10 mm, and the flowback time is 200 h. The reservoir porosity is 0.2, the reservoir thickness is 5 m, the reservoir Young's modulus is 4530 MPa, the Poisson's ratio is 0.23, and the reservoir density is 2350 kg/m³. The fracturing range is 100 m, the number of fracture stages is 17, the average fracture spacing is 76.47 m, and the average fracture aperture is 5.42 mm. The equivalent permeability corresponding to meshed fracture network is calculated by formula (1), the equivalent permeability corresponding to tufted fracture network is calculated by formula (2), the equivalent permeability corresponding to tree-like fracture network is calculated by formula (3), and the equivalent permeability corresponding to feather-like fracture network is calculated by formula (4).

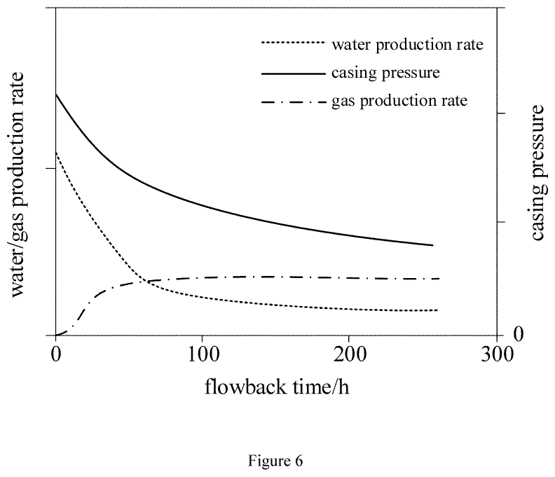

Performing numerical simulations on the water production rate, the gas production rate and the casing pressure of the horizontal well A according to the reservoir physical parameters corresponding to the feather-like fracture network and the second production data, and according to the result of numerical simulation, drawing a layout of structure of flow field corresponding to the feather-like fracture network in the fracturing fluid flowback stage, as shown in FIG. 6.

In FIG. 6, according to the change trend of the production curves presented by the layout of structure of flow field corresponding to the feather-like fracture network, it can be seen that the production curves (or flowback curves) comprise one production stage, and do not comprise pure water production stage and production rate rising stage, and the casing pressure keeps decreasing. Therefore, when the actual production curve diagram does not include pure water production stage and water production rate rising stage, and the casing pressure keeps dropping, then the actual reservoir flow field structure after fracturing is consistent with the flow field structure formed by meshed network fracture.

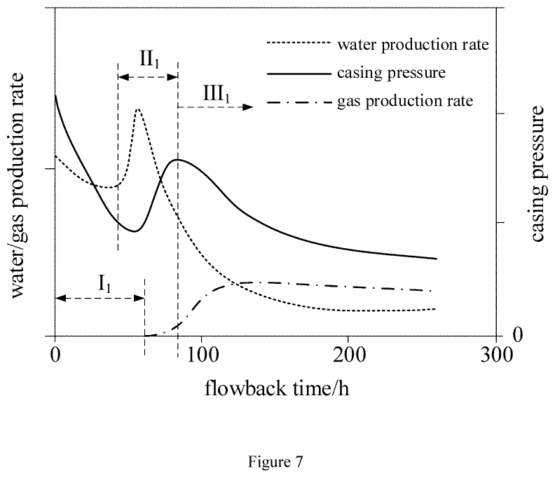

Performing numerical simulations on the water production rate, the gas production rate and the casing pressure of the horizontal well A according to the reservoir physical parameters corresponding to the tufted fracture network and the second production data, and according to the result of numerical simulation, drawing a layout of structure of flow field corresponding to the tufted fracture network in the fracturing fluid flowback stage, as shown in FIG. 7.

In FIG. 7, according to the change trend of the production curves presented by the layout of structure of flow field corresponding to the tufted fracture network, it can be seen that the production curves comprise three production stages: pure water production stage (stage I₁), water production rate rise and casing pressure rise stage (stage II₁), and two-phase discharge stage (stage III₁). Therefore, when the actual production curve diagram comprises a pure water production stage, and a water production rate rise and casing pressure rise stage, then the actual reservoir flow field structure after fracturing is consistent with the flow field structure formed by tufted network fracture.

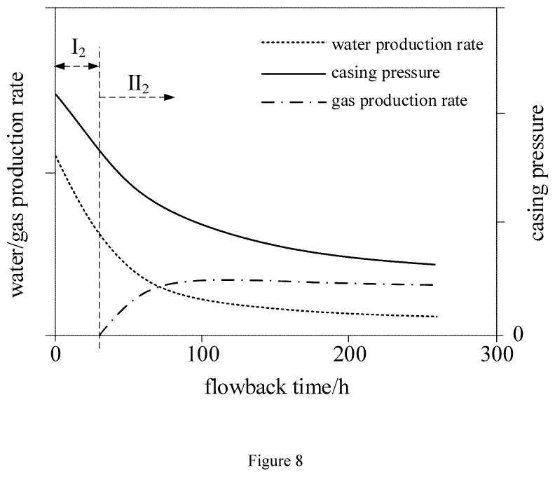

Performing numerical simulations on the water production rate, the gas production rate and the casing pressure of the horizontal well A according to the reservoir physical parameters corresponding to the tree-like fracture network and the second production data, and according to the result of numerical simulation, drawing a layout of structure of flow field corresponding to the tree-like fracture network in the fracturing fluid flowback stage, as shown in FIG. 8.

In FIG. 8, according to the change trend of the production curves presented by the layout of structure of flow field corresponding to the tree-like fracture network, it can be seen that the production curves comprise two production stages: pure water production stage (stage I₂), and gas production rate maintenance stage (stage II₂). And it does not include water production rate rising stage. Therefore, when the actual production curve diagram comprises a pure water production stage, and does not include water production rate rising stage, and the gas production rate is maintained for at least 240 hours without decreasing, then the actual reservoir flow field structure after fracturing is consistent with the flow field structure formed by tree-like network fracture.

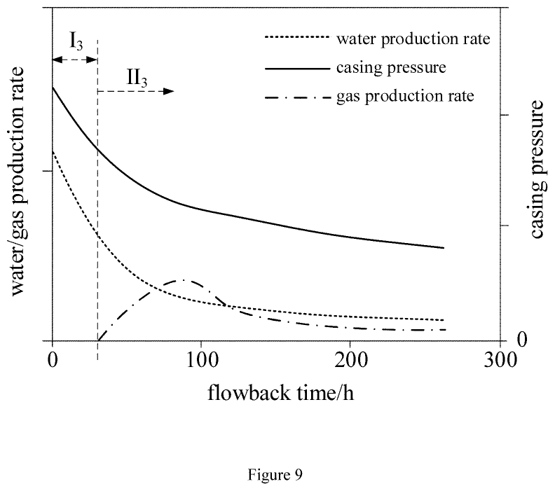

Performing numerical simulations on the water production rate, the gas production rate and the casing pressure of the horizontal well A according to the reservoir physical parameters corresponding to the feather-like fracture network and the second production data, and according to the result of numerical simulation, drawing a layout of structure of flow field corresponding to the feather-like fracture network in the fracturing fluid flowback stage, as shown in FIG. 9.

In FIG. 9, according to the change trend of the production curves presented by the layout of structure of flow field corresponding to the feather-like fracture network, it can be seen that the production curves comprise two production stages: pure water production stage (stage I₃), and the stage where the gas production rate rises and then rapidly drops (stage II₃). And it does not include water production rate rising stage. Therefore, when the actual production curve diagram comprises a pure water production stage, and does not include water production rate rising stage, and the gas production rate rises and then rapidly drops, then the actual reservoir flow field structure after fracturing is consistent with the flow field structure formed by feather-like network fracture.

Based on this, it can be seen from the actual production curve diagram shown in FIG. 5 that the actual production curve diagram obviously has a pure water production stage (stage I₁), a water production rate rising and casing pressure rising stage (stage II₁), and a two-phase discharge stage (stage III₁), which conform to the change trend of production curves in the layout of structure of flow field corresponding to the tufted fracture network. Therefore, the structure of flow field in the fractured reservoir corresponding to horizontal well A is identified as a structure of flow field formed by tufted fracture network.

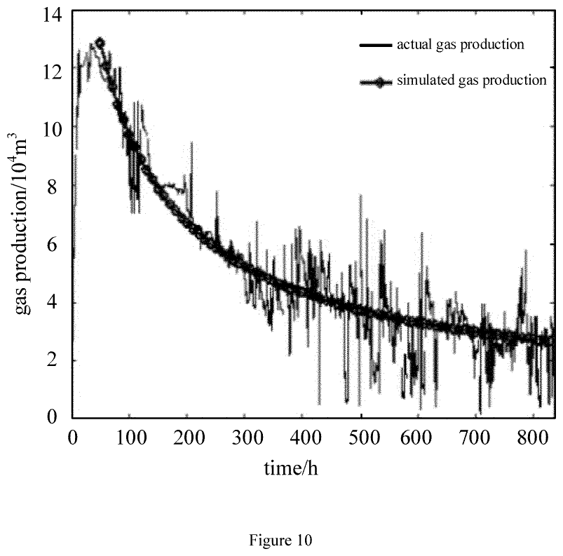

On the basis of confirming that the structure of flow field in the fractured reservoir corresponding to horizontal well A is identified as a structure of flow field formed by tufted fracture network, the later production process simulation of horizontal well A is carried out. The rock matrix is black shale, the fracture network is tufted fracture network, the fracturing range is 100 m, the equivalent permeability is 0.135 μm², the number of fracturing stages is 17, the average fracturing spacing is 76.47 m, the average fracture aperture is 5.42 mm, and the simulated production time is 850 days. The comparison between the simulated gas production curve and the actual gas production curve is shown in FIG. 10. It can be seen from FIG. 10 that the gas production curve obtained by the numerical simulation is basically consistent with the actual gas production curve, indicating that the result that the structure of flow field in the fractured reservoir corresponding to horizontal well A is a structure of flow field formed by tufted fracture network is accurate. On this basis, the design and adjustment of the later production plan can meet the actual development requirements and achieve the purpose of improving the recovery.

A device for identifying structure of flow field in unconventional gas reservoir is provided. The device comprises a processor and a memory.

The processor is configured to support the device for identifying structure of flow field in unconventional gas reservoir to perform one or more steps in the method for identifying structure of flow field in unconventional gas reservoir described in any of the above embodiments. The processor may be a central processing unit (CPU for short), or other general-purpose processors, digital signal processors (DSP), application-specific integrated circuits (ASIC), field programmable gate arrays (FPGA) or other programming logic devices, discrete gates or transistor logic devices, discrete hardware components, etc. Among them, the general-purpose processor may be a microprocessor or the processor may also be any conventional processor.

The memory stores computer program instructions suitable for execution by the processor, and when the computer program instructions are executed by the processor, one or more steps of the method for identifying structure of flow field in unconventional gas reservoir in any of the above embodiments are executed.

The memory can be a read-only memory (ROM) or other types of static storage devices that can store static information and instructions, random access memory (RAM) or other types of dynamic storage devices that can store information and instructions. The memory can also be electrically erasable programmable read-only memory (EEPROM), compact disc read-only memory (CD-ROM) or other optical disc storage, optical disc storage (comprising compact disc, Laser discs, optical discs, digital universal discs, Blu-ray discs, etc.), magnetic disk storage media or other magnetic storage devices, or any other medium that can be used to carry or store desired program codes in the form of instructions or data structures and that can be accessed by a computer, but not limited to this. The memory can exist independently and is connected to the processor through a communication bus. The memory can also be integrated with the processor.

In the description of this specification, the description with reference to the terms “one embodiment/mode”, “some embodiments/modes”, “examples”, “specific examples”, or “some examples” etc. that the specific features, structures, materials or characteristics described in combination with the embodiments/modes or examples are included in at least one embodiment/method or example of the present application. In this specification, the schematic representations of the aforementioned terms do not necessarily refer to the same embodiment/mode or example. Moreover, the described specific features, structures, materials or characteristics can be combined in any one or more embodiments/modes or examples in a suitable manner. In addition, those skilled in the art can combine the different embodiments/modes or examples and the features of the different embodiments/modes or examples described in this specification without contradicting each other.

In addition, the terms “first” and “second” are used only for the purpose of description and cannot be understood as indicating or implying relative importance or implicitly indicating the number of technical features indicated. Therefore, the features defined with “first” and “second” may explicitly or implicitly include at least one of the features. At the same time, in the description of the present disclosure, unless otherwise clearly stipulated and limited, the terms “connected” and “connection” should be understood in a broad sense, for example, they may be fixed connection, detachable connection, or integral connection; It can be a mechanical connection or an electrical connection; and it can be directly connected or indirectly connected through an intermediate medium. For those of ordinary skill in the art, the specific meaning of the above-mentioned terms in the present disclosure can be understood according to specific circumstances.

Those skilled in the art should understand that the abovementioned embodiments are only for clearly illustrating the present disclosure, rather than limiting the scope of the present disclosure. For those skilled in the art, other changes or modifications can be made on the basis of the above disclosure, and these changes or modifications are still within the scope of the present disclosure.

What is claimed is:

1. A method for identifying structure of flow field in unconventional gas reservoir, the unconventional gas reservoir comprises at least one horizontal well, and in the case of ignoring inter-well interference, for any horizontal well in the at least one horizontal well, the method for identifying structure of flow field in unconventional gas reservoir comprises:
during fracturing fluid flowback stage, obtaining first production data, and drawing an actual production curve diagram of the fracturing fluid flowback stage according to the first production data;
obtaining reservoir physical parameters corresponding to different fracture network forms and second production data, and performing numerical simulations on water production rate, gas production rate and casing pressure of the fracturing fluid flowback stage, and according to the results of numerical simulations, drawing layouts of structure of flow field corresponding to different fracture network forms of the fracturing fluid flowback stage; and
comparing the actual production curve diagram with the layouts of structure of flow field corresponding to different fracture network forms to identify structure of flow field of the reservoir after fracturing.

2. The method for identifying structure of flow field in unconventional gas reservoir according to claim 1, wherein, that obtaining second production data and reservoir physical parameters corresponding to different fracture network forms, and performing numerical simulations on water production rate, gas production rate and casing pressure in the fracturing fluid flowback stage, and according to the results of numerical simulation, drawing layouts of structure of flow field corresponding to different fracture network forms in the fracturing fluid flowback stage, comprises:
presetting fracture network form of the reservoir after fracturing to be one of a feather-like fracture network, a meshed fracture network, a tufted fracture network, and a tree-like fracture network, obtaining the second production data, and obtaining reservoir physical parameters corresponding to the four fracture network forms of feather-like fracture network, meshed fracture network, tufted fracture network, and tree-like fracture network respectively;
performing numerical simulations on the water production rate, the gas production rate and the casing pressure of the horizontal well according to the reservoir physical parameters corresponding to the tufted fracture network and the second production data, and according to the result of numerical simulation, drawing a layout of structure of flow field corresponding to the tufted fracture network in the fracturing fluid flowback stage;
performing numerical simulations on the water production rate, the gas production rate and the casing pressure of the horizontal well according to the reservoir physical parameters corresponding to the meshed fracture network and the second production data, and according to the result of numerical simulation, drawing a layout of structure of flow field corresponding to the meshed fracture network in the fracturing fluid flowback stage;
performing numerical simulations on the water production rate, the gas production rate and the casing pressure of the horizontal well according to the reservoir physical parameters corresponding to the tree-like fracture network and the second production data, and according to the result of numerical simulation, drawing a layout of structure of flow field corresponding to the tree-like fracture network in the fracturing fluid flowback stage; and
performing numerical simulations on the water production rate, the gas production rate and the casing pressure of the horizontal well according to the reservoir physical parameters corresponding to the feather-like fracture network and the second production data, and according to the result of numerical simulation, drawing a layout of structure of flow field corresponding to the feather-like fracture network in the fracturing fluid flowback stage.

3. The method for identifying structure of flow field in unconventional gas reservoir according to claim 2, wherein, the reservoir physical parameters corresponding to the meshed fracture network comprise equivalent permeability corresponding to the meshed fracture network, wherein formula of the equivalent permeability corresponding to the meshed fracture network is:
$${K}_{e 1} = {\sum }_{i = 1}^{n} \frac{{W}_{i}^{4}}{12 {X}_{i} ( {W}_{i} + {X}_{i} )} + {\sum }_{i = 1}^{n} \frac{{X}_{i}}{{W}_{i} + {X}_{i}} {K}_{m}$$
wherein, Kₑ₁ is overall permeability of fracture-matrix system of the meshed fracture network;
Kₘ is permeability of matrix system;
W is fracture aperture;
X is fracture spacing; and
n is number of fracture stage.

4. The method for identifying structure of flow field in unconventional gas reservoir according to claim 2, wherein, the reservoir physical parameters corresponding to the tufted fracture network comprise equivalent permeability corresponding to the tufted fracture network, wherein formula of the equivalent permeability corresponding to the tufted fracture network is:
$${K}_{e 2} = {\sum }_{i = 1}^{n} \frac{{W}_{i}^{3} {cos}^{2} γ}{12 ( {W}_{i} + {X}_{i} )} + {\sum }_{i = 1}^{n} \frac{{X}_{i}}{{W}_{i} + {X}_{i}} {K}_{m}$$
wherein, Kₑ₂ is overall permeability of fracture-matrix system of the tufted fracture network;
Kₘ is permeability of matrix system;
W is fracture aperture;
X is fracture spacing;
n is number of fracture stage; and
γ is angle between fractures.

5. The method for identifying structure of flow field in unconventional gas reservoir according to claim 2, wherein, the reservoir physical parameters corresponding to the tufted fracture network comprise equivalent permeability corresponding to the feather-like fracture network, wherein formula of the equivalent permeability corresponding to the feather-like fracture network is:
$${K}_{e 3} = {\sum }_{i = 1}^{n} \frac{{W}_{i} {cos}^{2} γ}{{W}_{i} + {X}_{i}} {K}_{m} + {\sum }_{i = 1}^{n} \frac{{X}_{i}}{{W}_{i} + {X}_{i}} {K}_{m}$$
wherein, Kₑ₃ is overall permeability of fracture-matrix system of the feather-like fracture network;
Kₘ is permeability of matrix system;
W is fracture aperture;
X is fracture spacing;
n is number of fracture stage; and
γ is angle between fractures.

6. The method for identifying structure of flow field in unconventional gas reservoir according to claim 2, wherein, the reservoir physical parameters corresponding to the tufted fracture network comprise equivalent permeability corresponding to the tree-like fracture network, wherein formula of the equivalent permeability corresponding to the tree-like fracture network is:
$${K}_{e 4} = {\sum }_{i = 1}^{n} \frac{{W}_{i}}{{X}_{i} + {W}_{i}} \frac{{Dd}_{max}^{3 + {D}_{τ}} ln ( {r}_{c} \text{/} {r}_{w} )}{256 ( 3 + {D}_{τ} - D ) {l}_{0}^{{D}_{τ}}} \frac{1 - γ}{1 - {γ}^{m + 1}}$$
wherein, Kₑ₄ is overall permeability of fracture-matrix system of the tree-like fracture network;
Kₘ is permeability of matrix system;
W is fracture aperture;
X is fracture spacing;
n is number of fracture stage;
γ is angle between fractures;
l₀ is length of level 0 bifurcation;
D is fractal dimension of fracture;
D_{τ} is tortuosity dimension;
dₘₐₓ is maximum opening of primary fracture;
m is maximum bifurcation levels of fracture;
r_{c} is maximum extension length of fracture; and
r_{w} is radius of wellbore.

7. The method for identifying structure of flow field in unconventional gas reservoir according to claim 2, wherein, that comparing the actual production curve diagram with the layouts of structure of flow field corresponding to different fracture network forms to identify structure of flow field of the reservoir after fracturing, comprises:
comparing the actual production curve diagram with the layout of structure of flow field corresponding to the feather-like fracture network, the layout of structure of flow field corresponding to the meshed fracture network, the layout of structure of flow field corresponding to the tufted fracture network, and the layout of structure of flow field corresponding to the tree-like fracture network respectively, and identifying structure of flow field of the reservoir after fracturing according to the changing trend of production curves presented by the four layouts of structure of flow field.

8. The method for identifying structure of flow field in unconventional gas reservoir according to claim 7, wherein, classification basis for identifying structure of flow field of the reservoir after fracturing comprises:
when the actual production curve diagram does not comprise pure water production stage and water production rate rising stage, and the casing pressure decreases continuously, the structure of flow field of the reservoir after fracturing is structure of flow field formed by meshed fracture network;
when the actual production curve diagram comprises a pure water production stage, and a water production rate rising and casing pressure rising stage, the structure of flow field of the reservoir after fracturing is structure of flow field formed by tufted fracture network;
when the actual production curve diagram comprises a pure water production stage, and does not comprise water production rate rising stage, and gas production rate is maintained for at least 240 hours without decreasing, the structure of flow field of the reservoir after fracturing is structure of flow field formed by tree-like fracture network; and
when actual production curve diagram comprises a pure water production stage, and does not include water production rate rising stage, and gas production rate rapidly drops after rising, the structure of flow field of the reservoir after fracturing is structure of flow field formed by feather-like fracture network.

9. The method for identifying structure of flow field in unconventional gas reservoir according to claim 1, wherein, the first production data comprises water production rate, water production, gas production rate, gas production and casing pressure.

10. A device for identifying structure of flow field in unconventional gas reservoir, wherein the device comprises a processor and a memory, and the memory stores computer program instructions suitable for execution by the processor, and when the computer program instructions are executed by the processor, one or more steps of the method for identifying structure of flow field in unconventional gas reservoir according to claim 1 are executed.
